(19) United States
(12) Patent Application Publication
(10) Pub. No.: US 2008/0282295 A1
(43) Pub. Date: Nov. 13, 2008

(54) Pausing and Resuming Content Streaming On Wireless Devices

(75) Inventors: Michael Gabriel, Fairfield County, CT (US); Craig D. Cuttner, Fairfield County, CT (US); Sarah Cotsen, New York County, NY (US); Robert M. Zitter, Fairfield County, CT (US); Jeffrey A. DiBartolomeo, Nassau County, NY (US); Bruce Probst, Westchester County, NY (US)

Correspondence Address: MENDELSOHN AND ASSOCIATES, P.C., 1500 JOHN F. KENNEDY BLVD., SUITE 405, PHILADELPHIA, PA, 19102, US

(73) Assignee: HOME BOX OFFICE, INC., New York, NY (US)

(21) Appl. No.: 11/630,608

(22) PCT Filed: Apr. 17, 2006
(86) PCT No.: PCT/US2006/014459

§ 371 Date: Dec. 19, 2006

Related U.S. Application Data
(60) Provisional application No. 60/672,341, filed on Apr. 18, 2005.

(51) Int. Cl. H04N 7/16

(52) U.S. Cl. 725/62

(57) ABSTRACT

In one embodiment, a communication system transmits video content in a looped manner using wireless communications to a cell phone capable of playing the content in a streaming manner. The cell phone is capable, after the playing of the received video content has been interrupted during a current transmission of the content, of resuming play of the content during a subsequent transmission of the looped content, based on the timing of the interruption. The timing of the interruption is compared to a schedule of content transmissions to determine when to resume the playing of the content, e.g., to enable the playing to resume from the location of the interruption.

### CROSS-REFERENCE TO RELATED APPLICATIONS

This application claims the benefit of the filing date of PCT application no. PCT/US2006/014459, filed on Apr. 17, 2006 as attorney docket no. 1073.005PCT, which claims the benefit of the filing date of U.S. provisional application No. 60/672,341, filed on Apr. 18, 2005 as attorney docket no. 1073.005PROV, the teachings of both of which are incorporated herein by reference.

### BACKGROUND OF THE INVENTION

1. Field of the Invention

The present invention relates to communications, and, in particular, to content (e.g., video) streaming on wireless devices, such as cellular telephones and other portable consumer electronic devices.

2. Description of the Related Art

Video streaming services for cell phones and the like are coming on line. However, the streaming of video content via wireless communication networks to portable, multi-functional devices such as cell phones that support both video streaming applications and traditional telephone communications, involves situations that are not likely to occur during conventional video streaming applications in which video content is transmitted via a wired (optical and/or electrical) communication network to a stationary, dedicated video processor, such as a digital video recorder/player. For example, a dedicated video processor does not have to handle incoming telephone calls during a video streaming application. Furthermore, a stationary video processor that receives video content via a wired cable network does not have to handle the loss of service associated with a mobile device, such as a cell phone, physically moving outside of the wireless service area.

### SUMMARY OF THE INVENTION

In one embodiment, the present invention involves (a) receiving a current transmission of content; (b) playing the received content during the current transmission; (c) interrupting the playing of the received content prior to the end of the content; (d) generating information related to timing of the interruption of the playing; and (e) resuming playing of the content during a subsequent transmission of the content, wherein the resumption of the playing of the content is based on the interruption-related information.

In another embodiment, the present invention involves (a) transmitting a schedule of content transmissions to a wireless device; and (b) transmitting content to the wireless device in a looped manner, where the wireless device (1) receives a current transmission of content; (2) plays the received content during the current transmission; (3) interrupts the playing of the received content prior to the end of the content; (4) generates information related to timing of the interruption of the playing; and (5) resumes playing of the content during a subsequent transmission of the content, wherein the resumption of the playing of the content is based on the interruption-related information and the schedule of content transmissions.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a portion of a communications system according to one embodiment of the present invention; and

FIG. 2 shows a flow diagram of exemplary processing implemented by the cell phone of FIG. 1, according to one implementation of the communications system of FIG. 1 in which the content server transmits looped video content.

### DETAILED DESCRIPTION

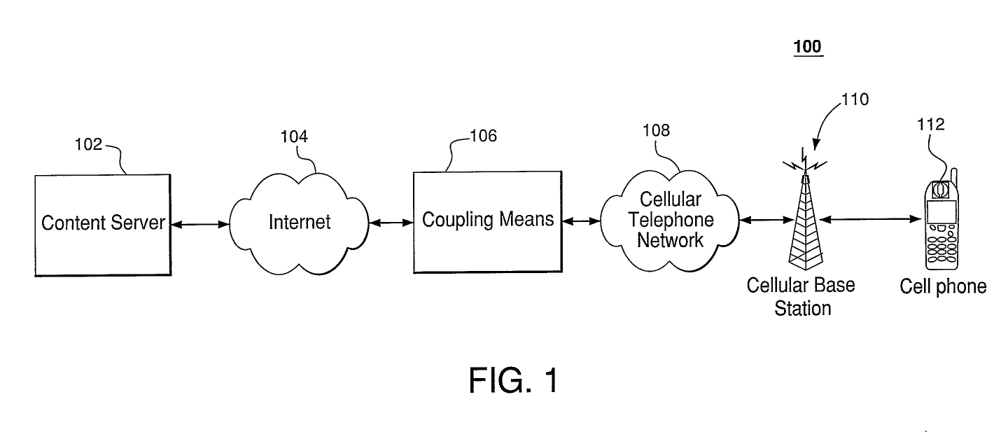

FIG. 1 shows a portion of a communications system 100, according to one embodiment of the present invention. In particular, FIG. 1 shows a content server 102 communicating with a cell phone 112 via a communication network that includes, in this particular embodiment, Internet 104, coupling means 106, cellular telephone network 108, and cellular base station 110. Although different implementations of communications system 100 may include different types of communications (e.g., electrical and/or optical, wired and/or wireless) between and within the various nodes shown in FIG. 1, the communications between cellular base station 110 and cell phone 112 are wireless communications conforming to any suitable known or future wireless communications standard. Communications system 100 is just one exemplary embodiment of the present invention; other embodiments may include different sets of nodes and different types of network configurations supporting communications between one or more content servers and one or more end users (e.g., cell phones).

In addition to supporting traditional mobile phone communications via cellular telephone network 108, cell phone 112 also supports a video streaming application in which video content is transmitted from content server 102 to cell phone 112 for play at cell phone 112. As used in this specification, the term “streaming” refers to the transmission and play of content in which the content is played substantially as the content is received at the playing device (i.e., in real-time), with minimal buffering of content data to handle jitter and other typical variations in the timing of the play of the content and to support buffering requirements inherent to video coding standards such as MPEG. Depending on the particular implementation, cell phone 112 may support a wide variety of functions and capabilities associated with such a video streaming application, some of which functions and capabilities will depend on the functions and capabilities of content server 102 and cellular telephone network 108.

In one possible implementation of communications system 100, a single stream of video content is transmitted from content server 102 to cellular telephone network 108, which converts that single video stream into a plurality of unicast streams, where each unicast stream is transmitted to a different cell phone, such as cell phone 112. In other implementations, the video content may be transmitted to the cell phones in a multicast or broadcast manner (where a single video stream is transmitted to multiple cell phones). In unicast and multicast transmissions, the recipients of the transmissions are known, while the recipients are not necessarily known in broadcast transmissions. For example, multi-mode cell phones that can interface with the infrastructure typically employed for cellular voice calls as well as the infrastructure typically employed for terrestrial digital television broadcasting are or soon will be available. For such devices, broadcast reception of digital video is possible. In addition, future “cellular telephony” infrastructures may also support broadcast transmissions.

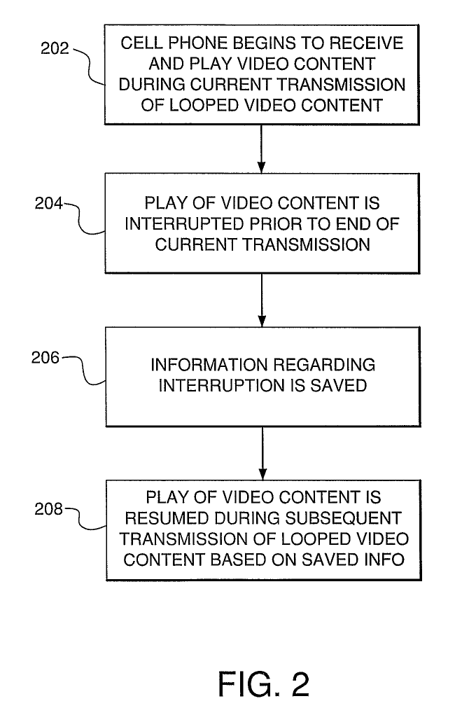

FIG. 2 shows a flow diagram of exemplary processing implemented by cell phone 112, according to one implementation of communications system 100 in which content server 102 transmits looped video content. Looped video content refers to the repeated transmission of the same video content by content server 102, where the different transmissions may be end-to-end or disjoint or overlapping. In end-to-end transmissions, the transmission of video content is re-started immediately following the end of the previous transmission. In disjoint transmissions, there is a period of time between the end of one transmission and the start of the next transmission. In overlapping transmissions, another transmission is started before the immediately previous transmission has ended. Note that more than two transmissions may be overlapping at the same time.

The processing of FIG. 2 begins with cell phone 112 receiving and playing streaming video content from content server 102 during a particular (i.e., current) transmission of the looped video content (step 202 of FIG. 2). The exact details as to how this particular video streaming session is initiated will vary depending on the particular implementation. In one implementation, cell phone 112 receives and stores a schedule of video content transmissions (i.e., “video programs”), e.g., from content server 102 to cellular telephone network 108, and the user uses cell phone 112 to send a request, e.g., to cellular telephone network 108, to request unicast transmission of a particular video program to cell phone 112. In another embodiment, each transmission of video content may include metadata identifying subsequent re-transmission times of that same content. If there is a significant delay between the time of the user's request and the start of the next looped transmission, cell phone 112 may receive a message via cellular telephone network 108 informing the user that the transmission of the requested video content is about to begin. The message may be audible or visual or both, including the use of special logo icons identifying the video content, such as a logo identifying the channel (e.g., an HBO channel logo) associated with the video content.

In another implementation, cellular telephone network 108 automatically transmits the video content, or notifications of available video content, to all of its associated cell phones (including cell phone 112), and the user of cell phone 112 determines whether to play the video content based on the locally stored transmission schedule, without cell phone 112 having to transmit any messages to request such transmission. In this case, cell phone 112 may generate a reminder to its user about upcoming transmission of video content pre-selected by the user.

In any case, at some point during the transmission of the streaming video content, the play of that video content at cell phone 112 may be interrupted (step 204). Such an interruption may result from many different situations. The user may actively pause the play, for example, to make an outgoing telephone call or accept an incoming telephone call or simply to take a break from watching the video content. Alternatively, the user may passively pause the play, for example, by previously specifying the phone number of a caller from whom an incoming call will automatically interrupt the play. Play may also be interrupted independent of the user's intention, for example, when cell phone 112 experiences a loss of signal after leaving the coverage area of cellular telephone network 108.

In any case, cell phone 112 reacts to the interruption of the play of the streaming video content by identifying appropriate information related to the timing of the interruption (step 206). Depending on the particular implementation, such information may be in the form of, for example, the frame number of the video content at which the interruption occurred (e.g., corresponding to the key (I) frame preceding the interruption), the date and time code at which the interruption occurred, or timing offset from the start of the transmission at which the interruption occurred. Furthermore, depending on the particular implementation, the information may be stored locally on cell phone 112 and/or transmitted for storage at cellular telephone network 108 and/or content server 102, for use during subsequent processing (such as during step 208 as described next).

If the interruption-related information is stored only locally, then the current transmission of video content to cell phone 112 may continue, even though cell phone 112 will not play that portion of the video content. In certain implementations, if the interruption-related information is transmitted, e.g., to cellular telephone network 108, then pausing of the play of the video content by cell phone 112 may trigger termination of the current transmission of the video content to cell phone 112.

Note that, for implementations that involve cell phone 112 transmitting a message to notify cellular telephone network 108 about the interruption of play, if the interruption resulted from a loss of signal (e.g., due to cell phone 112 leaving the coverage area of the network), then cell phone 112 would have to wait until communications with cellular telephone network 108 were reacquired before being able to transmit such a message.

According to the processing scenario of FIG. 2, during some subsequent transmission of the looped video content, play of the video content at cell phone 112 is resumed, where the resumption of playing is based on the stored information related to the timing of the interruption (step 208). Exactly how the play of the video content gets resumed and from what point in the transmission will depend on the particular implementation and/or options selected by the user. For example, in one scenario, based on the time that the play was interrupted in step 204 and its stored transmission schedule, cell phone 112 automatically determines the date and time of an equivalent point in the video content during a subsequent transmission of the looped content and notifies the user in advance that resumption of the play is available, to enable the user to choose whether or not to exercise that option. In another scenario in which the interruption information is transmitted and stored by cellular telephone network 108, network 108 determines the equivalent point in the video content and transmits a message to cell phone 112 to prompt and enable the user to resume play of the video content.

For implementations in which the transmission of looped video content to cell phone 112 depends on whether cell phone 112 is actually playing the video content, cell phone 112 will transmit a request, e.g., to cellular telephone network 108, to resume transmission after the interruption of step 204. On the other hand, for implementations in which the transmission of looped video content to cell phone 112 proceeds independent of whether cell phone 112 is actually playing the video content, cell phone 112 can independently resume playing the video content based on its stored transmission schedule, without having to transmit a request for resumption of transmission.

Although the processing of FIG. 2 corresponds to a situation in which the play of video content is resumed during a subsequent transmission of the looped video content at approximately the same location in the video content at which the play was previously paused, cell phone 112 may provide the user with one or more of the following options:
Resume play of the same transmission of the looped video content, albeit with a gap in the video content corresponding to the duration of the pause;
Resume play of the video content with a user-specified (positive or negative) time offset relative to the location of the pause. For example, this would enable the user to resume play during a subsequent transmission of the video content at a location 5 minutes before the video content was interrupted; and
Resume play of the video content from the beginning of the content during a subsequent transmission.

### Messaging

The need for and details regarding messages transmitted to and from cell phone 112 of FIG. 1 will depend on the particular implementation of communication system 100. For some implementations, the only messaging related to the streaming video application is the downloading of the transmission schedule to the cell phone, after which, the cell phone is able to operate independently to start, pause, and resume play of transmitted video content. At the other extreme are implementations in which cell phone 112 transmits requests upstream to start, pause, and/or resume video transmissions for play at the cell phone.

For implementations involving such messaging, the messages may include one or more of the following types of information (as appropriate):
Identification of the cell phone;
Identification of the content server;
Identification of the video content;
Identification of the particular transmission of the video content;
Function requested (e.g., start transmission, pause transmission, resume transmission);
Video frame or other identifier of a particular location in the video content;
Authentication and authorization data; and
Time code(s) associated with the message and/or the function to be implemented.
   For example, in addition to identifying the requested function, a request to start transmission of video content may include identification of the requesting cell phone and identification of the particular transmission of video content. In addition to this same information, a request to pause or resume transmission of video content may also include the video frame corresponding to the pause.

### ALTERNATIVE EMBODIMENTS

Although communication system 100 of FIG. 1 has been described in the context of streaming video content (which is typically assumed to include audio data as well as video data) in a looped manner, alternative communication systems can also be implemented in other suitable contexts. For example, a communication system can be implemented in the context of streaming only audio content. A communication system can also be implemented in the context of streaming text, e.g., for electronic book applications. A communication system can also be implemented in non-streaming contexts in which data is transmitted and buffered or otherwise stored at the cell phone for non-real-time playback. Such implementations might or might not involve looped transmissions.

Although communication system 100 has been described in the context of cell phones, alternative communication systems can be implemented in the context of other types of receivers, including mobile or stationary, wired or wireless receivers that might or might not support traditional telephone communications.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

We claim:

1. A method comprising:
(a) receiving a current transmission of content;
(b) playing the received content during the current transmission;
(c) interrupting the playing of the received content prior to the end of the content;
(d) generating information related to timing of the interruption of the playing; and
(e) resuming playing of the content during a subsequent transmission of the content, wherein the resumption of the playing of the content is based on the interruption-related information.

2. The invention of claim 1, wherein:
the content is video content played in a streaming manner;
the method is implemented by a wireless device; and
the content is transmitted in a looped manner to the wireless device using wireless communications.

3. The invention of claim 2, wherein the wireless device is further adapted to function as a cell phone.

4. The invention of claim 2, wherein the content is transmitted to the wireless device in a unicast manner.

5. The invention of claim 1, further comprising the step of receiving and storing a schedule of content transmissions, wherein the timing of the interruption is compared to the schedule of content transmissions to determine timing for the resumption of the playing of the content during the subsequent transmission.

6. The invention of claim 1, wherein the current transmission of the content contains data corresponding to the timing of the subsequent transmission of the content.

7. The invention of claim 1, wherein step (e) comprises:
(1) generating a user prompt regarding the resumption of the playing of the content during the subsequent transmission; and
(2) determining whether to resume the playing of the content based on a user response to the user prompt.

8. The invention of claim 1, wherein the playing of the received content is directly interrupted by a user.

9. The invention of claim 1, wherein the playing of the received content is indirectly interrupted by a user, wherein the playing is automatically interrupted upon detection of a condition for interrupting the playing, wherein specification of the condition by the user was previously received.

10. The invention of claim 1, wherein the playing of the received content is interrupted by a loss of signal of the current transmission.

11. The invention of claim 1, further comprising transmitting the interruption-related information for use in non-local processing.

12. The invention of claim 1, wherein:
the content is video content played in a streaming manner;
the method is implemented by a wireless device further adapted to function as a cell phone;
the content is transmitted in a looped manner to the wireless device using unicast wireless communications;
further comprising the step of receiving and storing a schedule of content transmissions; and
the timing of the interruption is compared to the schedule of content transmissions to determine timing for the resumption of the playing of the content during the subsequent transmission.

13. The invention of claim 12, wherein step (e) comprises:
(1) generating a user prompt regarding the resumption of the playing of the content during the subsequent transmission; and
(2) determining whether to resume the playing of the content based on a user response to the user prompt.

14. Apparatus comprising:
(a) means for receiving a current transmission of content;
(b) means for playing the received content during the current transmission;
(c) means for interrupting the playing of the received content prior to the end of the content;
(d) means for generating information related to timing of the interruption of the playing; and
(e) means for resuming playing of the content during a subsequent transmission of the content, wherein the resumption of the playing of the content is based on the interruption-related information.

15. The invention of claim 14, wherein:
the content is video content played in a streaming manner;
means (a)-(e) are part of a wireless device further adapted to function as a cell phone;
the content is transmitted in a looped manner to the wireless device using unicast wireless communications;
further comprising means for receiving and storing a schedule of content transmissions; and
the timing of the interruption is compared to the schedule of content transmissions to determine timing for the resumption of the playing of the content during the subsequent transmission.

16. The invention of claim 14, wherein the current transmission of the content contains data corresponding to the timing of the subsequent transmission of the content.

17. A method comprising:
(a) transmitting a schedule of content transmissions to a wireless device; and
(b) transmitting content to the wireless device in a looped manner, wherein the wireless device is adapted to:
(1) receive a current transmission of content;
(2) play the received content during the current transmission;
(3) interrupt the playing of the received content prior to the end of the content;
(4) generate information related to timing of the interruption of the playing; and
(5) resume playing of the content during a subsequent transmission of the content, wherein the resumption of the playing of the content is based on the interruption-related information and the schedule of content transmissions.

18. The invention of claim 17, wherein:
the content is video content played in a streaming manner;
steps (a)-(b) are implemented using a content server;
the wireless device is further adapted to function as a cell phone;
the content is transmitted in a looped manner to the wireless device using unicast wireless communications; and
the timing of the interruption is compared to the schedule of content transmissions to determine timing for the resumption of the playing of the content during the subsequent transmission.

19. A communications system comprising:
(a) means for transmitting a schedule of content transmissions to a wireless device; and
(b) means for transmitting content to the wireless device in a looped manner, wherein the wireless device is adapted to:
(1) receive a current transmission of content;
(2) play the received content during the current transmission;
(3) interrupt the playing of the received content prior to the end of the content;
(4) generate information related to timing of the interruption of the playing; and
(5) resume playing of the content during a subsequent transmission of the content, wherein the resumption of the playing of the content is based on the interruption-related information and the schedule of content transmissions.

20. The invention of claim 19, wherein:
the content is video content played in a streaming manner;
means (a)-(b) are part of a content server;
the wireless device is further adapted to function as a cell phone;
the content is transmitted in a looped manner to the wireless device using unicast wireless communications; and
the timing of the interruption is compared to the schedule of content transmissions to determine timing for the resumption of the playing of the content during the subsequent transmission.
